(19) United States
(12) Patent Application Publication
(10) Pub. No.: US 2013/0120544 A1
(43) Pub. Date: May 16, 2013

(54) METHOD AND DEVICE FOR PROVIDING SUPPLEMENTARY CONTENT IN 3D COMMUNICATION SYSTEM

(71) Applicants: Lin Du, Beijing (CN); Jian Ping Song, Beijing (CN); Wen Juan Song, Beijing (CN)

(72) Inventors: Lin Du, Beijing (CN); Jian Ping Song, Beijing (CN); Wen Juan Song, Beijing (CN)

(73) Assignee: THOMSON LICENSING, Issy de Moulineaux (FR)

(21) Appl. No.: 13/810,224

(22) PCT Filed: Jul. 21, 2011
(86) PCT No.: PCT/CN2011/077434

§ 371 Date: Jan. 15, 2013

(30) Foreign Application Priority Data
Jul. 21, 2010 (CN) PCT/CN2010/001100

(51) Int. Cl. H04N 13/04

(52) U.S. Cl. CPC H04N 13/04
USPC 348/51

(57) ABSTRACT

It is provided a method for providing a main 3D content and a supplementary content used in a 3D multimedia device. The method comprises the steps of displaying the main 3D content; and triggering the supplementary content by a 3D related event of the main 3D content, wherein, depth value of the supplementary content is updated along with depth value change of the main 3D content.

### FIELD OF THE INVENTION

The present invention relates to a method and a device for providing a main 3D content and a supplementary content in the 3D communication system.

### BACKGROUND OF THE INVENTION

Digital communication systems such as DVB-H (Digital Video Broadcasting—Handheld), DVB-T (Digital Video Broadcasting—Terrestrial) or other client-server communication system, enable end users to receive digital contents including video, audio, and data. Using a fixed or mobile terminal, a user may receive digital contents over a cable or wireless digital communication network. For example, a user may receive video data such as a broadcast program in a data stream as main content. A supplementary content associated with the main content, such as an interactive multimedia content including program title, news, interactive services, or additional audio, video and graphics may also be available.

The supplementary content is a collection of multimedia data, such as graphics, text, audio and video etc, which may change over time based on the main content which may be an audio/video (A/V) stream. The A/V stream has its own timeline, here, the timeline is a term used to describe that a video/audio sequence is ordered by time stamp. The corresponding interactive multimedia content also has a timeline, which relates to this A/V stream timeline by a reference, such as a start point tag. That is, there is a temporal synchronization between the corresponding interactive multimedia content and the A/V stream. The start point tag refers the specific time point of the timeline of A/V stream. When the A/V stream plays to the specific time point, an event is triggered to play the corresponding interactive multimedia content.

The 2D content related information service has been studied in 2D interactive media, or 2D rich media during the past years and many organizations and companies are working on standardization and industrialization of this technology. The BCAST Working Group of OMA (Open Mobile Alliance) published an enabler of RME (Rich-Media Environment); the 3GPP (3rd Generation Partnership Project) published DIMS (Dynamic and Interactive Multimedia Scenes); ISO/IEC publishes LASeR (Lightweight Application Scene Representation) as its international standard/recommendation for 2D rich media; and Adobe Flash and Microsoft SilverLight are the two popular 2D interactive media technologies used in the Internet.

The 2D content related information service usually includes a main content (e.g. 2D live video, animation, etc.) and a supplementary content (e.g. video, audio, text, animation, graphics, etc.), while the current rich media specifications only focus on how to present different 2D media elements on time line by defining the load, start, stop, and unload time of each media element.

During the past years, 3D stereo technology such as 3D interfaces and interactions have been attracting a lot of interests in both academia and industry. But due to the hardware limits especially on 3D inputs and displays, the usability of 3D interface is still not good enough for mass market. However, with the recent development and deployment of 3D stereoscopic displays, the 3D displays start to come into the commercial market instead of the very limited professional market.

The basic idea of 3D stereo appeared in 19th century. Because our two eyes are approximately 6.5 cm apart from each other, each eye sees a slightly different angle of view of a scene we are looking at and provides a different perspective. Our brain can then create the feeling of depth within the scene based on the two views from our eyes. FIG. 1 shows the basic concept of the 3D stereoscopic displays, wherein Z is the depth of perceived object and D is the distance to the screen, four objects are perceived as in front of the screen (the car), on the screen (the column), behind the screen (the tree) and at the infinite distance (the box). If the left figure of the object can be seen by the right eye, and the right figure of the object can be seen by the left eye, the depth of the object will be positive and perceived as in front of the screen such as the car. Otherwise the depth of the object will be negative, and perceived as behind the screen such as the tree. If the two figures of the object are just opposite to the two eyes, the depth of the object will be infinite. Most modern 3D displays are built based on the 3D stereo concepts, with the major difference on how to separate the two views to left and right eyes respectively.

In the 3D content related information service, one may expect 3D interactive media transmission and display including main content and supplementary content. Therefore, it is important to have the triggering and displaying of the supplementary content in 3D communication system.

### SUMMARY OF THE INVENTION

The invention concerns a method for providing a main 3D content and a supplementary content used in a 3D multimedia device, comprising: displaying the main 3D content; and triggering the supplementary content by a 3D related event of the main 3D content.

The invention also concerns a 3D multimedia device for providing a main 3D content and a supplementary content, comprising: a 3D display for displaying the main 3D content; and a user terminal for triggering the display of the supplementary content by a 3D related event of the main 3D content.

The invention also concerns a method for providing multimedia contents including a main 3D content and a supplementary content, comprising: providing the main 3D content to be played; and generating the supplementary content for being triggered by a 3D related event of the main 3D content, and played together with the main 3D content or separately.

### BRIEF DESCRIPTION OF DRAWINGS

These and other aspects, features and advantages of the present invention will become apparent from the following description of an embodiment in connection with the accompanying drawings:

FIG. 1 shows the basic concept of the 3D stereoscopic displays in the prior art;

FIG. 2 is a block diagram showing a 3D multimedia device according to an embodiment of the invention;

FIG. 3 is a block diagram showing an event trigger list according to an embodiment of the invention;

FIG. 4 is an illustrative example showing event triggers according to the embodiment of the invention;

FIG. 5 is an illustrative example showing 3D supplementary content triggers according to the embodiment of the invention; and

FIG. 6 is a flow chart showing a method for providing supplementary content according to the embodiment of the invention.

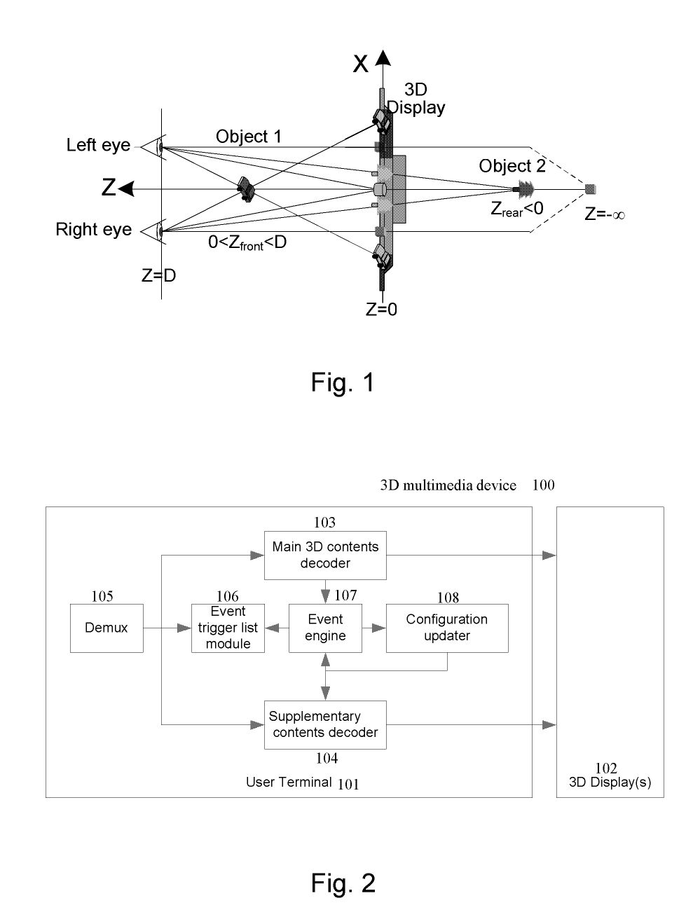

### DETAILED DESCRIPTION OF PREFERRED EMBODIMENTS

In the following detailed description, a system and a method for providing a main 3D content and a supplementary content are set forth in order to provide a thorough understanding of the present invention. However, it will be recognized by one skilled in the art that the present invention may be practiced without these specific details or with equivalents thereof. In other instances, well known methods, procedures, components and circuits have not been described in detail as not to unnecessarily obscure aspects of the present invention.

FIG. 2 is a block diagram showing a 3D multimedia device 100 according to an embodiment of the invention. As shown in FIG. 2, the 3D multimedia device 100 includes a user terminal 101 and at least one 3D display 102. The user terminal 101 and 3D display 102 can be combined into a single device, or can be separate devices such as Set Top Box (STB), a DVD/BD player or a receiver, and a display. The user terminal 101 includes a 3D interactive media de-multiplexer (demux) 105, a main 3D content decoder 103, a supplementary content decoder 104, an event engine 107, an event trigger list module 106, and a configuration updater 108.

The 3D interactive media content are created and transmitted from a head-end device (not shown) and the process of the terminal 101 starts when the terminal receives the multimedia content including the main and supplementary content. Here, the head end device is a kind of device that provides such functions as multiplexing, retiming, transmitting, and so on, which can be also called server device. The multimedia content can also be stored in a removable storage medium such as a disc (not shown) to be played by the client device 100, or stored in a memory of the client device.

According to the embodiment of the invention, the multimedia contents including a main 3D content and a supplementary content are provided to the client device 100. The main 3D content will be played on the display 102, and the supplementary content can be triggered by a 3D related event of the main 3D content, and played together with the main 3D content on the display 102. Here the supplementary content is not limited to 3D content; it can also be 2D content or even can be audio information. In addition, the multimedia contents further comprise event triggers including 3D related event triggers for linking the main 3D content and the supplementary content together.

A 3D event trigger may be a conditional expression in a description file of the main 3D content, such as a given region or object's depth in the main 3D content exceeding a certain value, or a given object's size in the main 3D content becoming smaller or bigger than a threshold. The main 3D content and the supplementary content are linked by the conditional expression in the description file including the related triggers.

The 3D interactive media demux 105 at the user terminal 101 analyzes the received multimedia contents through a network or from a storage medium, and extracts the main 3D content, the supplementary content, and the event triggers linking them together. The main 3D content may be 3D live broadcasting videos or 3D animations, the supplementary content could include 3D video clips, 3D graphic models, 3D user interfaces, 3D applets or widgets, and the event triggers could be some combinations of conditional expression on time, 3D object position, 3D object posture, 3D object scale, covering relationship of the objects, user selections, and system events.

After been decoded by the main 3D content decoder 103, the main 3D content is played on the 3D display 102. The supplementary content is stored in a local buffer with given validness period and ready to be rendered, and the event triggers in the description file are pushed into an event trigger list module 106 sorted by trigger conditions. The trigger conditions can be a specific time point of the timeline of the main 3D content, or a 3D related trigger. As mentioned above, the 3D related trigger can be a specific value or range of the 3D depth, 3D position, 3D posture and 3D scale of the main 3D content, covering relationship of the objects and so on.

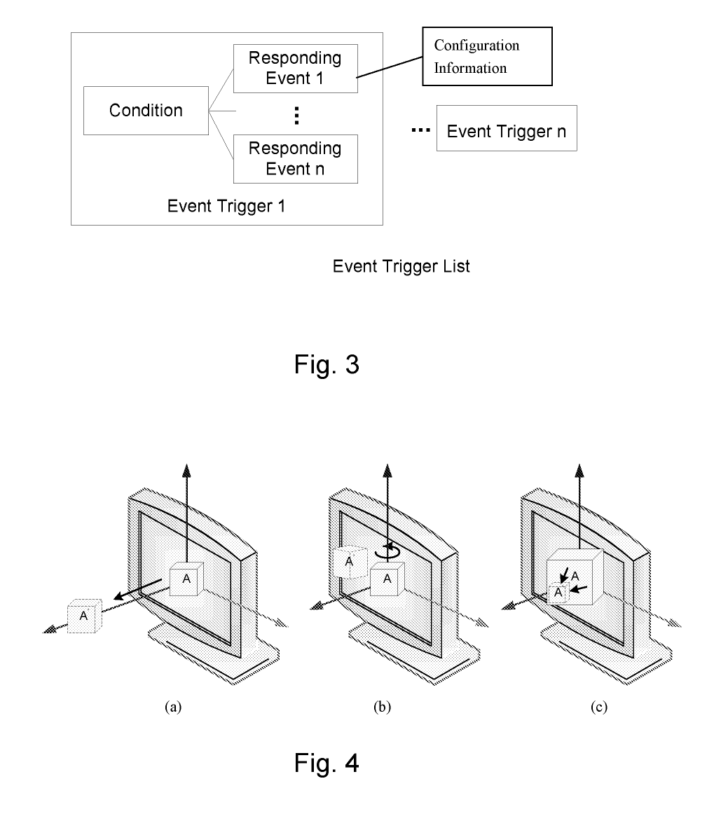

FIG. 3 is a block diagram showing an event trigger list according to an embodiment of the invention. Event Trigger 1, . . . , Event Trigger n, are elements of the Event Trigger List. Each event trigger includes a trigger condition as mentioned above, and a responding event. The responding event includes several actions to be implemented, such as updating stored original configuration information of the supplementary content, displaying the supplementary content. Configuration information can be position, posture, scale and other configurable parameters of the supplementary content. The configuration information can be updated by the configuration updater 108 based on the main 3D content as required.

During the playing back of the main 3D content, the event triggers are being interpreted and checked regularly by the event engine 107. Different trigger types require different checking mechanism and checking frequency. For example to check the depth trigger (position Z type), we need to extract the depth information of the given region from the main 3D content, then compare with the trigger conditions to decide if the trigger should be fired. If the main 3D content is 2D video plus depth map, the depth information can be directly fetched from the depth map. If the main 3D content is frame-compatible format, e.g. side-by-side or top-and-bottom, the depth information can be calculated using image processing algorithms, such as edge detection, feature point correlation, etc. For time related event triggers, the checking frequency can be a range from each video frame to several hours or days, depending on the pre-defined real time level in the event trigger. As soon as any event trigger meets its firing condition, that is, the trigger condition is occurred in the main 3D content, the event engine 107 searches the local buffer for the associated supplementary content and sends to the supplementary content decoder 104. The decoded supplemental content is then displayed on the display 102. The supplementary content and the main 3D content can be shown on the same display or separate displays.

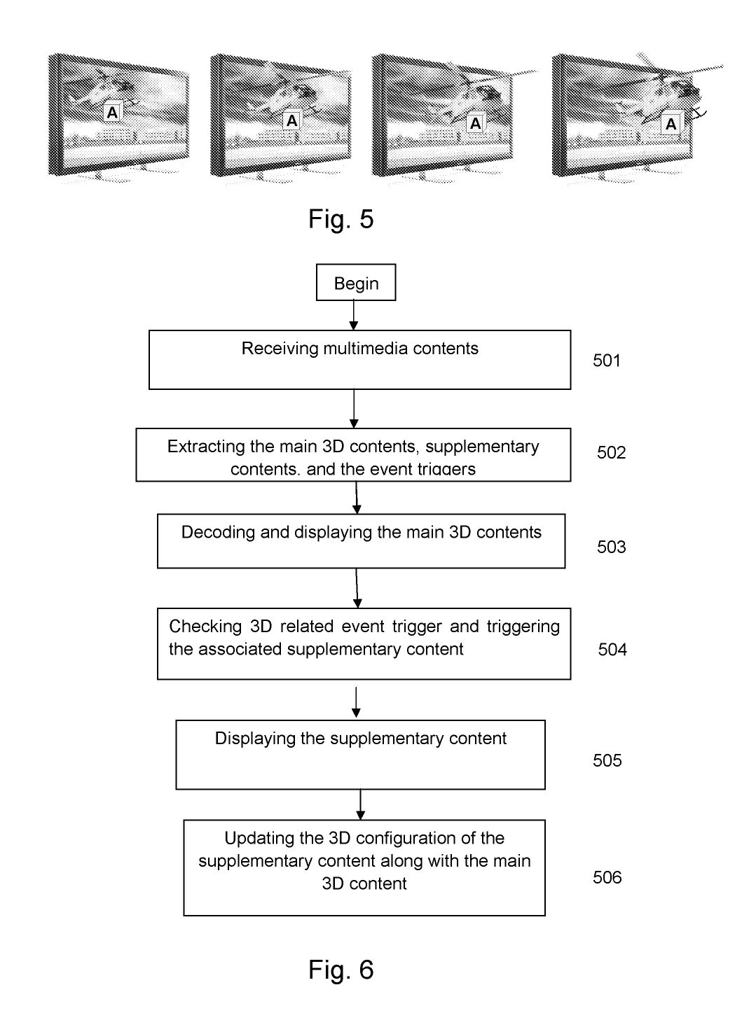

Once an event trigger is fired, the event engine 107 will notify the configuration updater 108. Then the configurations of the supplementary content are updated by the configuration updater 108 along with the change of the main 3D content. The configuration of supplementary content is stored in the event trigger list module 106 of the client device 100 during their life cycle. The updater 108 can modify the configuration data for the related supplementary content, such as updating the position information of the object A in FIG. 5, so as to reflect the changes made by the responding events from the event triggers.

FIG. 4 is an illustrative example showing a 3D supplementary content trigger according to the embodiment of the invention. It shows three examples of event triggers shown in the 3D display 102 based on 3D related trigger. For example, when the original object A of the main 3D content (can be either 3D object/regions/patterns from 3D video or 3D graphic models from 3D animations) move/rotate/zoom to the new object A′ in FIGS. 4(a), 4(b) and 4(c) respectively, the pre-defined event triggers stored in the event trigger list will be triggered.

According to an embodiment of the invention, the main 3D content could be the live broadcasting of 3D world cup football match. A 3D related event trigger is defined with the condition that the ball has moved across a given 3D region (the goal). The supplementary content of the billboard and all players' 3D information, together with pre-defined 3D presentation configuration, is associated with the event trigger.

The event engine 107 of the user terminal 101 analyzes the 3D live video by recognizing and tracking the ball. This could be done using pattern recognition and motion tracking algorithms in computer vision technologies. For example, the condition of the event trigger can be checked in the real-time with the current image processing techniques, such as the combination of video frame extraction, image segmentation, edge extraction, feature extraction, pattern recognition, motion tracking, template matching, etc. to finally decide whether the ball has crossed the edge of the goal. When the ball has been kicked into the goal, the trigger will be fired. Then the event engine 107 of the user terminal 101 searches the local buffer to find the associated supplementary content, i.e. the billboard and all players' 3D information.

Then the supplementary content are updated, that is the score on the billboard is updated and presented on the 3D display 102 according to pre-defined 3D configurations and the configuration update along with the change of the main 3D content. The event engine 107 also finds the specific shooter's 3D information and presents it similarly.

FIG. 5 is an illustrative example showing 3D supplementary content triggers according to the embodiment of the invention. It shows an adaptive depth value of supplementary content according to the interested object during the playing of main 3D content.

The initial configurations with position, posture, scale and other configurable parameters for the supplementary content are fetched from the related supplementary content event trigger in the event trigger list by the configuration updater 108. Once an event trigger is fired, event engine 107 will notify the configuration updater 108. Then the configurations of the supplementary content are updated by the configuration updater 108 according to the changes of the main 3D content to provide user a consistent feeling on the whole presentation. For instance, the depth value of an information bar such as a bar of text information, e.g. the subtitle of the video should be dynamically adjusted when the depth value of user focused object in the main 3D video changes significantly, so that user does not need to move his eye balls from the main object and the information bar frequently. An example is shown in FIG. 5 with the supplementary content (i.e. the box A) always sticking to the interested object (i.e. the helicopter) in the main 3D content when it is moving out of the screen. The 3D configuration of the box A is updated during the whole process. The 3D configuration information along the timeline for supplementary content is pre-defined or automatically generated from the main 3D content using pattern recognition and motion tracking algorithms in computer vision technologies, such as the position of box A in FIG. 5 can be pre-defined or automatically generated using the position of the helicopter with a fixed offset. The position of the helicopter can be detected using the image processing techniques similar to those used to detect goal shooting example.

When the supplementary content gets expired, its playing will be stopped and removed from the local buffer. Of course, the user can also stop the playing back of the main 3D content or supplementary content at any time.

According to the method of the embodiment, content related events with different 3D related trigger types are provided, and 3D supplementary content for 3D content related information service with a updated configuration based on the main 3D content are presented in 3D display systems, to give users an exciting but still comfortable experience.

The traditional content related information services only defined how to present the main and the supplementary content along the timeline, while in 3D space, more criteria should be considered to trigger the events of presenting the supplementary content, such as media time, 3D position, posture, or scale of graphic objects, user selections, and etc. When any pre-defined event trigger is fired, the handling process of the associated event is then started including presenting the related supplementary content.

In addition, in conventional 2D interactive media services, the supplementary content is presented according to the pre-defined position on the screen, while in 3D space, not only the position but also the depth are important to provide user a consistent feeling on the whole presentation in the 3D interactive media services on 3D display systems. Since the depth distribution of each frame in the main 3D video usually varies significantly, the depth values of the 3D supplementary content also need to be adapted to the depth map of the main 3D content.

In 3D interactive media services, the depth information of different media content needs to be well defined to give user a consistent feeling on the whole presentation on 3D display systems, and the content relationships also need to be extended from only timeline synchronization to support more 3D applications. Therefore, this invention is aimed to solve the problem on how to trigger content related events and present 3D supplementary content for 3D interactive media service in 3D display systems.

FIG. 6 is a flow chart showing a method for providing a supplementary content according to the embodiment of the invention. At step 501, the multimedia contents are received by the user terminal 101 of the 3D multimedia device 100. Then at step 502, the demux 105 extracts the main 3D content, the supplementary content, and the event triggers from the received multimedia contents, and at step 503 the main 3D content is decoded and displayed on the 3D display 102. At step 504 the event engine 107 checks 3D related event trigger according to the 3D related event of the main 3D content and triggers the associated supplementary content decoded by the supplementary content decoder 104. Then at step 505 the decoded supplementary content is displayed on the same 3D display with the main 3D content or another display. At step 506 the 3D configuration of the supplementary content is updated along with the main 3D content.

The foregoing merely illustrates the embodiment of the invention and it will thus be appreciated that those skilled in the art will be able to devise numerous alternative arrangements which, although not explicitly described herein, embody the principles of the invention and are within its spirit and scope.

1-12. (canceled)

13. A method for providing a main 3D content and a supplementary content used in a 3D multimedia device, comprising:
displaying the main 3D content; and
triggering the supplementary content by a 3D related event of the main 3D content, wherein, depth value of the supplementary content is updated along with depth value change of the main 3D content.

14. The method according to claim 13, wherein the 3D related event is compared to predetermined trigger conditions, for triggering the supplementary content when the predetermined trigger conditions are occurred in the main 3D content.

15. The method according to claim 13, wherein the 3D related event of the main 3D content is part of a group comprising a depth value of the main 3D content, a 3D position, a 3D posture and a 3D scale of an object or a region of the main 3D content.

16. The method according to claim 13, further comprising displaying the supplementary content together with the main 3D content or separately from the main 3D content.

17. The method according to claim 13, wherein the supplementary content is a collection of multimedia data including graphics, text, audio and/or video, and 3D image.

18. The method according to the claim 13, wherein, the main 3D content comprises an object interesting for user, the depth value of the supplementary content is updated to make the supplementary content stick to the object in the main 3D content.

19. A 3D multimedia device for providing a main 3D content and a supplementary content, comprising:
a 3D display for displaying the main 3D content;
a user terminal for triggering the display of the supplementary content by a 3D related event of the main 3D content; and
an updater for updating depth value of the supplementary content along with depth value change of the main 3D content.

20. The 3D multimedia device according to claim 19, further comprising an event trigger list module for storing the 3D related event triggers including a depth value of the main 3D content, a 3D position, a 3D posture and a 3D scale of an object or a region of the main 3D content.

21. The 3D multimedia device according to claim 19, further comprising an event engine for checking the event triggers, comparing the 3D related event to predetermined trigger conditions, and searching the associated supplementary content to be displayed when the predetermined trigger conditions are occurred in the main 3D content.

22. The 3D multimedia device according to the claim 19, wherein, the main 3D content comprises an object interesting for user, the updater updates the depth value of the supplementary content to make the supplementary content stick to the object in the main 3D content.
